(19) United States
(12) Patent Application Publication
(10) Pub. No.: US 2014/0149583 A1
(43) Pub. Date: May 29, 2014

(54) SOCIAL NETWORK FORENSIC APPARATUS AND METHOD FOR ANALYZING SNS DATA USING THE APPARATUS

(71) Applicant: Electronics and Telecommunications Research Institute, Daejeon (KR)

(72) Inventors: Youn Hee GIL, Daejeon (KR); Joo Young Lee, Daejeon (KR)

(21) Appl. No.: 13/934,009

(22) Filed: Jul. 2, 2013

(30) Foreign Application Priority Data
Nov. 26, 2012 (KR) 10-2012-0134290

(51) Int. Cl. H04L 29/08

(52) U.S. Cl. CPC H04L 67/22
USPC 709/224

(57) ABSTRACT

Disclosed are an apparatus and a method that determine a human relationship having an online relationship with a specific user by using user information and a friend relationship that exist on a social network service, transmitted and received data, and the like, determine communication information based on the human relationship, and enable additional analysis such as a time based status progress analysis, or the like. In particular, a more comprehensive and accurate analysis result is presented by simultaneously information on two or more social network services for one person.

### CROSS-REFERENCE TO RELATED APPLICATIONS

This application claims priority to and the benefit of Korean Patent Application No. 10-2012-0134290 filed in the Korean Intellectual Property Office on Nov. 26, 2012, the entire contents of which are incorporated herein by reference.

### TECHNICAL FIELD

The present invention relates to a social network forensic apparatus and a method for analyzing SNS data using the apparatus. More particularly, the present invention relates to a social network forensic apparatus and a method for analyzing SNS data using the apparatus that determine a human relationship of a specific user by using data which exists on a social network service and perform various analyses based on the human relationship.

### BACKGROUND ART

An existing social media analysis technique includes a technology that recognizes social media data as big data and analyzes the recognized big data as data which is communicated through social media is vast, a field that studies a social network structure, a technical field that studies interaction on the social network, and the like.

In this regard, an existing patent includes Korean Patent Publication No. 10-2011-0115776. The patent discloses a method of quantifying intimacy between users by using information on the social network. The patent discloses even a method of quantitatively analyzing an interactive social networking relationship by using a frequency of messages which interactively are transmitted to and received from followers in a twitter.

However, since the related art is not an analysis based on an event, it is impossible to examine user's marginal persons and whereabouts. A data amount to be processed is vast, and as a result, it takes a lot of time to determine a human relationship of a specific person and a scheme of utilizing the human relationship is not proposed, and as a result, human relationship information fades away.

### SUMMARY OF THE INVENTION

The present invention has been made in an effort to provide a social network forensic apparatus and a method for analyzing SNS data using the apparatus that determine a human relationship of a specific user from data which exist on a social network service based on a specific event and perform various analyses based on the human relationship.

An exemplary embodiment of the present invention provides a social network forensic apparatus, including: an SNS data collecting unit collecting social network service (SNS) data of analysis targets; an SNS data integrating unit integrating SNS data of the same analysis target among the collected SNS data; an SNS data analyzing unit calculating intimacy with other targets by analyzing the integrated SNS data; and an SNS data retrieving unit retrieving SNS data which conform with input text values among the integrated SNS data.

The apparatus may further include an event related information collecting unit collecting event related information associated with an input event, in which the SNS data collecting unit may collect the SNS data of each analysis target by connecting the social network service based on information on analysis targets included in the collected event related information.

The SNS data collecting unit may store SNS data of each analysis target which include a time when each SNS data is collected and identification information granted to each SNS data.

The apparatus may further include an SNS data converting unit converting each collected SNS data into data in a common format.

The SNS data integrating unit may integrate SNS data stored in a database with the SNS data of each analysis target by using information on an input analysis target.

The SNS data analyzing unit may calculate the intimacy by using relationship information with other targets acquired by connecting a social network service.

The SNS data analyzing unit may use a connection degree with other targets which are linked and a frequency a frequency of messages transmitted to and received from other targets as the relationship information.

The apparatus may further include an analysis result reporting unit reporting the calculated intimacy and a retrieval result as an analysis result of the integrated SNS data.

Another exemplary embodiment of the present invention provides a method for analyzing SNS data of a social network forensic apparatus, including: collecting social network service (SNS) data of analysis targets; integrating SNS data of the same analysis target among the collected SNS data; calculating intimacy with other targets by analyzing the integrated SNS data; and retrieving SNS data which conform with input text values among the integrated SNS data.

The method may further include collecting event related information associated with an input event, in which in the collecting of the SNS data, the SNS data of each analysis target may be collected by connecting the social network service based on information on analysis targets included in the collected event related information. The collecting of the event related information may be performed before the collecting of the SNS data.

In the collecting of the SNS data, SNS data of each analysis target which include a time when each SNS data is collected and identification information granted to each SNS data may be stored.

The method may further include converting each collected SNS data into data in a common format. The converting of the SNS data may be performed between the collecting of the SNS data and the integrating of the SNS data.

In the integrating of the SNS data, SNS data stored in a database may be integrated with the SNS data of each analysis target by using information on an input analysis target.

In the analyzing of the SNS data, the intimacy may be calculated by using relationship information with other targets acquired by connecting a social network service.

In the analyzing of the SNS data, a connection degree with other targets which are linked and a frequency of messages transmitted to and received from other targets may be used as the relationship information.

The method may further include reporting the calculated intimacy and a retrieval result as an analysis result of the integrated SNS data. The reporting of the analysis result may be performed after the retrieving of the SNS data.

Since persons who use an online social network service tend to simultaneously use two or more services, an association analysis of two or more social network data with other evidence data is required. It is possible to determine a more accurate human relationship by assigning a weight when multilinks are made in calculating intimacy when the association analysis is used.

A message analysis technique based on a text search will also be requested in forensic investigation as the social network service is used as new communication means. A frequency of a specific text used in a dialogue with a specific person, a list of friends who make a dialogue by using the specific text, and the like may be important clues in investigation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically illustrating a social network forensic apparatus according to an exemplary embodiment of the present invention.

FIG. 2 is a block diagram schematically illustrating a configuration which may be added to the social network forensic apparatus of FIG. 1.

FIG. 3 is a structural diagram of a social network forensic system according to an exemplary embodiment of the present invention.

FIG. 4 is a configuration diagram of an online social network forensic system.

FIGS. 5A to 6 are exemplary diagrams of mergence of multiple social networks for one person.

FIGS. 7 and 8 are exemplary diagrams illustrating a method of merging users having a friend relationship judged as the same person.

FIG. 9 is an exemplary diagram of arraying one example associated with interaction between two persons in chronological order.

FIG. 10 is a flowchart schematically illustrating a method for analyzing SNS data of a social network forensic apparatus according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

The present invention belongs to a study field that acquires desired information by analyzing information transmitted on an online social network service and data such as a human relationship, or the like.

In recent years, the use of a social network service has increased with the development of a mobile environment such as a smart phone, a tablet PC, or the like. Unlike a web service which is primarily based on communities such as a blog, a cafe and the like in the past, the social network service is based on the human relationship and tends to be used as a new information exchanging means among users due to the attribute. The online social network service provides a platform that enables the users to make a relationship with each other online and share information, and as a result, communication based thereon has gradually increased and a vast amount of information is circulated through the communication. Therefore, the online social network service has been evaluated as a primary medium that secures important evidential materials in civil and criminal suits. Actually, Gartner prospects that over half the electronic evidences requested during an entire electronic evidence disclosure process will be materials collected in social media late in 2013.

Since the online social media are evaluated as one medium in which information, emotion, and opinions of persons who live in modern times are communicated with each other, a study to analyze the medium to use the analyzed medium for the purpose such as marketing a public opinion survey, or the like is in active progress. Studies about a topology analysis of the online social network are also made for the purpose such as qualitative improvement of a service, a policy decision, or the like and as an e-Discovery solution, a product called X1 Social Discovery which is a product released in 2012 by X1 forensically exists. The X1 Social Discovery provides a function to collect, index, and retrieve Facebook, Twitter, Linkedln data for a specific account in real time. However, the X1 Social Discovery just provides an analysis based on a text but does not include an analysis function for a social network structure. Since social network data is data based on a connection relationship between a person and a person unlike data just collected in a web, when data which is communicated in association with an internal human relationship is analyzed, more meaningful information may be forensically acquired.

A social network means all human relationships which humans naturally establish. The human becomes a member of various communities regardless of human own intention while the human was born to be brought up. The human may naturally become a member of a local community and alumnus depending on a region in which the human was born and brought up, and an alma mater or may join in a group having a common concern with a specific purpose of oneself. While a new human network is continuously generated and extended through the process, the human leads a life while living various activities therethrough. Even though a proposition that the human is a social animal is not mentioned, it is apparent that the human ceaselessly is anxious for a new relationship (network), and the human acquires information and achieves an object to be personally pursued through the network. Enabling the action which is pursued in a real life online is the social network service. In particular, as a personal expression desire becomes stronger, and the online social network service establishing a social relationship between persons and maintaining an acquaintance relationship has been also gradually developed.

The online social network service is one type of social media based on the human relationship, which generates and reinforces the social relationship through free communication and information sharing, and expansion of human connections among users. The social media means an opened online platform that enables sharing of personal thinking, opinion, experience, information, or the like, and generate and extend a relationship with other persons. In this sense, all of a blog, a UCC, or the like as well as the social network are included in the social media. According to Boyd et al., the social network service is defined as a service that provides the following functions.
To enable a user who subscribes to the service to prepare a profile or a content which is openable (alternatively, partially openable) in a relevant system. Therefore, the service user may retrieve a user having a common concern in the system.
To enable the user who subscribes to the service to establish the human relationship with other users in the system. Therefore, the service user may form a new human network.
To the user who subscribes to the service to check status (postings, etc.) of other users having the human relationship in the relevant system. The social network service enables the users to share new information and communicate with each other through the functions.

Facebook, Twitter, Cyworld, and the like as social network services which are widely used at present may be considered as typical online social network services which meet the above conditions. Besides, in the event of Kakaotalk which is one of applications used by a lot of smart phone users in Korea, Kakaotalk itself should be classified into a mobile instant messenger not the social network service when only the above conditions are considered. However, with the advent of a Kakao story service which is a photo sharing service which recently interlocks with the Kakaotalk service, the Kakaotalk also tends to be classified into the social network service.

The social network service is primarily used for promotion of good fellowship and entertainment at an initial stage, but thereafter, the social network service tends to be used for a productive purpose such as business, sharing of various pieces of information, or the like. There are lots of persons who find up-to-date information and use the information through the social network rather than Internet searching. Due to a feature in which acquaintances of acquaintances are connected in most events, information which is shared by a friend's recommendation has higher reliability and simpler transferred than information found through general searching. Functions of various social network services include a function to reveal a personal own identity such as a photo, personal information, a hobby, an interest, or the like, a relationship establishing function for individuals to establish relationships and accumulate the established relationships in a system, such as friend/acquaintance making, becoming a fan, or the like, a function to support communications among users, such as an e-mail, a message, chatting, a messenger, or the like, a function for the user to produce contents in the system, such as the blog, the photo, a moving picture, or the like in addition to a profile, a function to use accumulated relationship networks such as sharing, recommending, and distributing of the user produced contents or external contents, cooperation, or the like, a group function to support various group activities, and the like.

Even in real life, individuals in a group express their own opinions and listen to other persons' opinions. In this process, new information is exchanged and the individuals communicate emotions with each other. The vast data are not refined and if desired data may be acquired by efficiently analyzing the vast data, the vast data may be used in various fields. The online social network is evaluated as a useful medium to acquire information, emotions, opinions, and the like which are communicated in one society because an evidence of the exchange in a group is intactly stored in the system.

Since the amount of data generated per time has explosively increased due to the increment of smart phone penetration rate and the spread of the social network service, a study for considering the vast data which are circulated through the social network service as a category of big data and effectively analyzing the vast data in accordance with a specialized purpose has been in active progress. The study includes a study about an emotion analysis using social network data and a study about future prediction. Since data which may be acquired through the social network includes various data including a video, audio, the photo, and the like in addition to a text, a lot of information may be acquired by analyzing the various data. An analysis study primarily using a text mining technique has been dominated up to now and collected data are analyzed by collecting human tweets by following Twitter users or by crawling an opened posting of Facebook. Since the social network services having large-scale users, such as Facebook and Twitter are used as means for hosting and transferring media data, a study about data spread through the social network has also been in progress.

A network structure study is a study field to describe and understand a phenomenon by simplifying various networks which exist in a real world by using a graph formed by connecting points and lines. Networks of the real world which may be considered in general include a human relationship network, a road network, an airline network, a communication network, the Internet, an in-cell metabolism network, and the like and the networks are substituted by graphs in which each node is set as the point and a link between nodes is set as the line to mathematically analyze the graphs for the study about the network structures. Each node in the above network is a subject having an interconnection structure, such as a city in the airline network, a computer in the communication network, or the like and the link represents an interconnection thereof. The number of the links connected to each node is a connection degree in the network structure analysis and the connection degree is divided into an in-degree and an out-degree depending on directionality thereof. In some events, a weight may be given.

When a connection structure of the online social network is understood through the graph, respective users may be represented by the points (nodes) and connection relationships of the users may be represented by the lines (links). The online social network structure study provides key information in deciding a new policy for improving the quality of the service and designing a new social network system.

Mislove at al. has found that the distribution of the number of links for each node follows a power-law distribution with respect to the structure of the online social network and has attributes of a small-world network and a scale-free network by using network data collected in Orkut, YouTube, LiveJournal, Flicker, and the like.

The power-law distribution is a distribution in which most observation values have a very low distribution and minor observation values have a very large value unlike a normal distribution having a bilateral symmetrical bell shape around an average value like a grade distribution and a weight distribution. This means that links to a public character are crowded in a social relationship network, while most persons have only a very small number of links.

The small-world network means a network having a tendency of clustering in which adjacent nodes are grouped and efficiency in which predetermined nodes in the network may be connected in a short step and may be described in association with a theory that all persons in the real world are acquaintances through several steps. The online social network as well as the actual human relationship network also has a grouping tendency among the same fellow workers, families, and friends. The scale-free network means a network that has no scale to represent the average value and means a network shape in which most nodes have only several connections, while a very small number of nodes have most connections. Due to a feature of the social network where a node having a high connection degree exists, an influence map may be prepared to be used for marketing by studying the structure.

When World Wide Web is described as an example, the World Wide Web is a network structure with directionality, which has one web page as a node and a hyper link that exists between web pages as a link. When an interlink of the web page is described, a link to a famous web page is provided in many other web pages, but in an opposite case thereto, the famous web page does not include links to all other web pages. This is a feature of a web graph used in a retrieval algorithm, such as PageRank, or the like. Unlike the web page having directionality, the social network has a symmetric link structure. In the social network structure, each node may be considered as human and a connection between human and human may be considered as a link. In the online social network, when a specific person makes a friend request and a person who receives the request is accepted, a personal connection is formed. Therefore, the link in the social network tends to have no predetermined directionality. This may be similar as an offline social human relationship network. As an experimental result, the above result may be verified and 65% of users having an upper 1% in-degree have an upper 1% out-degree. This is contrary to a case of the web in which the users are equal to or less than 20%.

In recent years, as the social network study, a study of analyzing interaction between users has been in active progress over the network structure study based on a connection relationship of the users. Benevenutoy et al. has revealed that a ratio of silent interaction such as visiting a page of a counterpart or reading a posting of the counterpart is higher than that of a visible action such as transferring a message to each other or making a comment by using the actual interaction on the social network, and Chun et al. has sorted and studied a friend network in which the users make friends and an active network in which actual interaction exits by using Cyworld visitors' book data. It has been revealed that the relationship network in which interaction exists has a weight and has a similar attribute as a social relationship network graph as a network with directionality. Viswanath et al. has verified that most activities in entire interaction occur among some users by studying a pattern for interaction among the users with the flow of time by using Facebook data. Wilson et al. has analyzed interaction by using local network data of Facebook in 2008 and proposed an interaction graph and applied the proposed interaction graph to Reliable Email and SybilGuard which are applications using an existing social graph to verify effectiveness thereof.

The study about the interaction of the social network starts from a doubt about whether all users who have the human relationship in the actual social network do specific actions therebetween. To this end, Wilson et al. has collected a profile for 22 local network users of Facebook, wall data, a photo, and the like and revealed that only very some of the users who have the actual human relationship communicate with each other as the study result. A graph that expresses the personal relationship in the social network is defined as a social graph and a graph that expresses intercommunication is defined as an interaction graph.

Besides, it has been revealed as a result of studying a role of the social network as information spreading means that users who are strongly connected exercise great influence on each other, but even users who are weakly connected have a large role in information propagation in the case of new information. In a study of analyzing a user's attribute by using Twitter account data, it has been revealed that even a sex, an age, a region, and a political tendency of a user can be analyzed by applying a vocabulary based social linguistic model by using a user's linguistic feature by collecting user's profile and twit in Twitter. Agichtein et al. has performed a study of finding meaningful data in a Question-Answer system of Yahoo by using the social network.

The present invention has been made in an effort to determine a relationship of an analysis target and associated persons by using multiple social network data, and analyze intimacy therebetween and information which is transmitted to and received from each other and in particular, to allow an analyzer to intuitively and effectively determine a phenomenon by visualizing a tendency of information based on time.

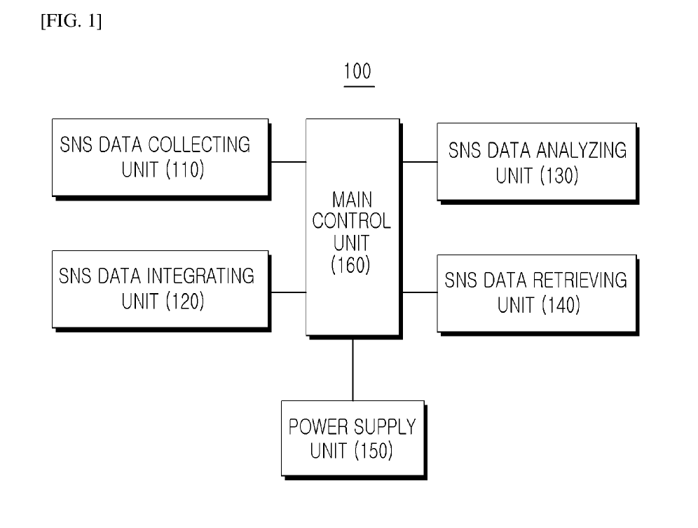

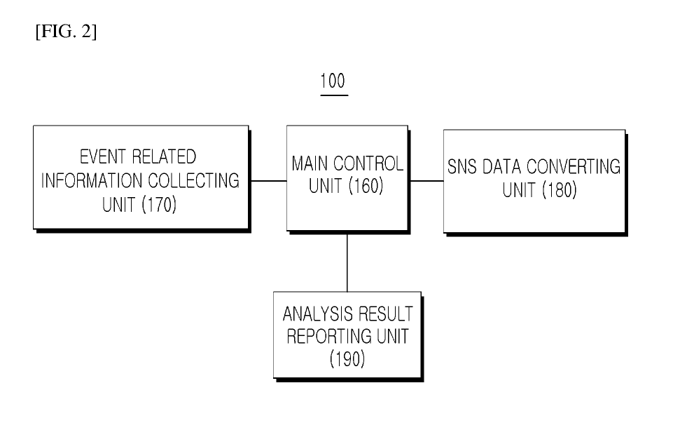

FIG. 1 is a block diagram schematically illustrating a social network forensic apparatus according to an exemplary embodiment of the present invention. FIG. 2 is a block diagram schematically illustrating a configuration which may be added to the social network forensic apparatus of FIG. 1.

Referring to FIG. 1, the social network forensic apparatus 100 includes an SNS data collecting unit 110, an SNS data integrating unit 120, an SNS data analyzing unit 130, an SNS data retrieving unit 140, a power supply unit 150, and a main control unit 160.

The SNS data collecting unit 110 serves to collect social network service (SNS) data of analysis targets. The SNS data collecting unit 110 serves to store SNS data of each analysis target which include a time when each SNS data is collected and identification information granted to each SNS data. As above, the time of collecting the SNS data means, for example, a timestamp and the identification information granted to the SNS data means, for example, a hash value.

The SNS data integrating unit 120 serves to integrate SNS data of the same analysis target in the collected SNS data. The SNS data integrating unit 120 may integrate SNS data stored in a database with the SNS data of each analysis target by using information on an input analysis target.

The SNS data analyzing unit 130 serves to calculate intimacy with other targets by analyzing the integrated SNS data. The SNS data analyzing unit 130 calculates intimacy by using relationship information with other targets acquired by accessing a social network service. In this event, the SNS data analyzing unit 130 uses a connection degree with other targets which are linked and a frequency of messages transmitted to and received from other targets as the relationship information.

The SNS data retrieving unit 140 serves to retrieve SNS data which conforms with an input text value among the integrated SNS data.

The power supply unit 150 serves to supply power to components constituting the social network forensic apparatus 100.

The main control unit 160 serves to control an overall operation of each component constituting the social network forensic apparatus 100.

Referring to FIG. 2, the social network forensic apparatus 100 may further include an event related information collecting unit 170, an SNS data converting unit 180, and an analysis result reporting unit 190.

The event related information collecting unit 170 serves to collect event related information associated with an input event. According to the function, the SNS data collecting unit 110 may collect the SNS data of each analysis target by accessing the social network service based on information on analysis targets included in the collected event related information. As above, the information on the analysis target includes account information used at the time of connecting a self social network service as the analysis target, that is, an ID and a password (PW).

The SNS data converting unit 180 serves to convert each collected SNS data into data of a common format. According to the function, the SNS data integrating unit 120 may integrate SNS data of the same analysis target for the SNS data converted to have the common format.

The analysis result reporting unit 190 serves to report the calculated intimacy and a retrieval result as an analysis result of the integrated SNS data.

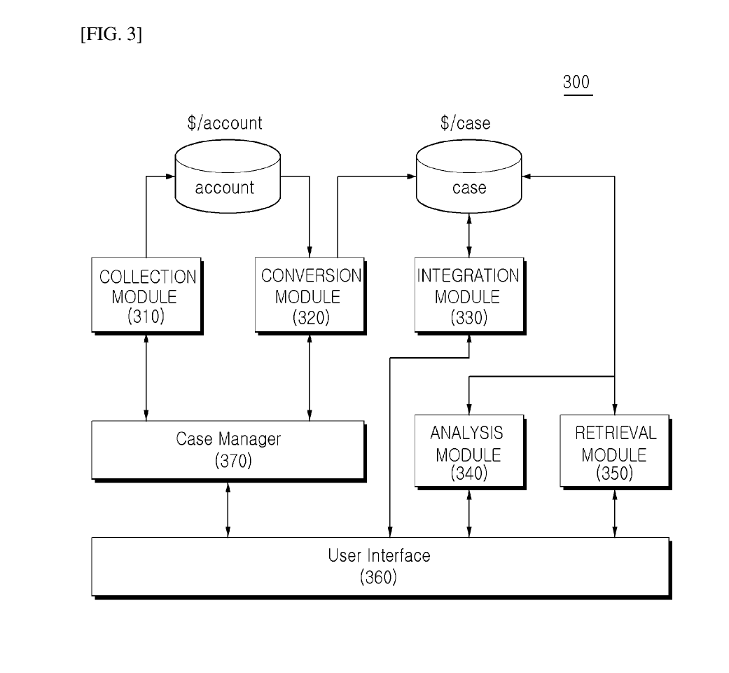

FIG. 3 is a structural diagram of a social network forensic system according to an exemplary embodiment of the present invention.

The social network forensic system 300 analyzes a human relationship and a user action by analyzing multiple social network service data. In FIG. 3, the system 300 collects social network data by using the ID and the password of the analysis target, receives and stores previously collected SNS data as a file, merges multiple SNS data while converting the stored SNS data into a defined common data format, and quantifies intimacy based on a link relationship and an interaction after integrating users having the same friend relationship, and performs text retrieval based on a connection relationship.

The social network forensic system 300 includes a collection module 310, a conversion module 320, an integration module 330, an analysis module 340, a retrieval module 350, a user interface 360, and an event manager 370.

The collection module 310 serves to download user data by connecting the social network service system such as Facebook, or the like by using user account information (ID/password) and store the downloaded user data in an internal storage.

The collection module 310 collects SNS data and conserves integrity after the collection time. The collection module 310 receives a Facebook data collection command from the event manager 370, connects Facebook by using a user ID and a password, and downloads Facebook data to store the downloaded Facebook data in an account storage. Hash values are calculated and timestamps are issued for respective downloaded files. When the SNS data is input from the event manager 370 as the file, the corresponding data is stored in the account storage, and the hash values are calculated and the timestamps are issued for the respective files.

The conversion module 320 serves to convert the stored data into the common data format.

The conversion module 320 serves to convert the SNS data on a path of the account storage, which is received from the event manager 370 into the common data format and store the corresponding format in an event storage. When received account data are two or more, the account data are integrated and stored based on a timeline.

The integration module 330 serves to grant an integration ID to the same person having different user names and integrate the users.

The integration module 330 receives information to be integrated from the user interface 360 and updates the user data in the event storage by using the corresponding information.

The analysis module 340 serves to analyze the human relationship by using relationship type data, or the like collected through the social network service.

The analysis module 340 analyzes intimacy between the users by analyzing interactive data in the event storage.

The retrieval module 350 serves to perform text retrieval for the collected data.

The retrieval module 350 retrieves an item which coincides with an input character string based on text based contents in the event storage.

The event manager 370 serves to perform an event based analysis function by managing an event file and processing event-related data.

The event manager 370 serves to generate a new event by receiving a user's input or load an existing event and store an event when an analysis ends. When the online SNS data needs to be collected, a module that collects the corresponding account information by receiving the user's ID and the password is called and when a message indicating that the collection ends is received, a conversion module that converts the account data into the common data format in the stored storage and stores the common data format is called.

The user interface 360 serves to interface each of the components 310 to 370 and a user terminal.

The user interface 360 calls a required module by receiving a command from a user.

The function of the social network forensic system 300 according to the present invention is divided into collection and conservation of the SNS data, integration and analysis for multiple SNS data of one person to be investigated, which is associated with a specific event, an event based analysis, and review and reporting for the integrated analysis result.

The collection and conservation function of the SNS data means a function to acquire the corresponding account information by accessing the social network service by using the user ID and the password and store the acquired information in a local storage of a collection server, and calculate a hash value for validating integrity therefor and issue the timestamp on the assumption that account information of a social network service to be investigated is known.

The integrated analysis for multiple SNS data of one person to be investigated means integrated analysis for two or more SNSs which one person uses and represents converting information collected by using respective SNS accounts into the common data format to analyze and retrieve the common data format by considering the common data format as one virtual account.

The event based analysis means a series of analysis processes of generating an event file having associated event information, an investigation time, investigator information, or the like as an attribute based on a unique event ID for SNS analysis and investigating an associated SNS account.

The review and reporting for the integrated analysis result means a function to visually display an overall analysis result on a screen so as for the user to verify the overall analysis result at a look and an automatic report generating function.

When the functions of the social network forensic system 300 described as above are considered, the social network forensic system 300 may be driven as follows.

First, in inputting an event generation command through the user interface 360, the user interface 360 requests event-associated information such as an event ID, a name and an affiliation of an analyzer, contact information, a related event, related SNS data information, other nodes, and the like to the analyzer, and receives event-related information from the event manager 370 and transfers an SNS data collection command to the collection module 310. The event related information collecting unit 170 of FIG. 2 may perform the above function.

Thereafter, the collection module 310 downloads SNS account data and stores the downloaded SNS account data in a local storage device. In this event, the collection module 310 collects and stores the online SNS data such as Facebook, or the like by using an ID and a password of a person to be analyzed according to the request or loads SNS data to be analyzed as the file and stores the loaded SNS data in the account storage. Thereafter, the collection module 310 issues the hash value and the timestamp for integrity of data.

The event manager 370 transmits a conversion command of related files to the conversion module 230 after transmitting a collection completion message and the conversion module 320 converts and integrates related account information in the account storage into the common data format and stores the common data format in the event storage.

Thereafter, when the integration module 330 is called by receiving a list of friends judged as the same person, that is, nodes to be integrated from the user through the user interface 360, the integration module 330 integrates the list of the friends judged as the same person in the friend list in the integrated account information stored in the event storage and updates related files.

A command to analyze interuser intimacy in a specific event is transmitted to the analysis module 340 through the user interface 360 at the time of analyzing the interuser intimacy, intimacy on an SNS is calculated by using a connection degree of the respective users linked with the person to be analyzed and a frequency of several transmitted and received messages depending on a time interval, and the calculated intimacy is stored as event information.

In character string retrieval based on a user relationship, the user transfers a character string to be retrieved to the retrieval module 350 through the user interface 360 and the retrieval module 350 retrieves contents based on a text from data stored in the event storage and hands over a hit item to the user interface 360. The user interface 360 shows a retrieval result in a format for the user to easily verify.

Data which exist on the social network service are generally classified into two types of a mini blog type and a dialogue type according to a characteristic thereof.
Mini blog type data
Personal status and emotion expression, and information sharing (Facebook, Twitter, Kakao Story)
Display of status which is left on personal wall
Dialogue type data
Communication for specific counterpart (Facebook, Twitter, Kakaotalk)
Message sent to and received from specific person
Posting which is left on wall of other person
Comment for posting of counterpart

When a characteristic of Facebook data is considered, a person primarily performs posting on his/her wall, and acquaintances make a comment or express sympathy (like, sharing), or the like, in the posting. The wall posting primarily includes text and multimedia data, and an application use record and a link of other sites which are automatically stored in a Facebook application are included in the wall posting. Metadata regarding the posting includes a posting uploading time, a tag, an uploading place, and the like. Interaction with other persons may be posted on walls of other persons and a 1:1 message may be sent to other persons. The wall posting is different from a message in that wall posting of other persons may be opened to other persons other than two persons and the message may be viewed by only transmitters/receivers. In general, a method of calculating a weight by weighting respective interaction may be used in order to quantify intimacy.

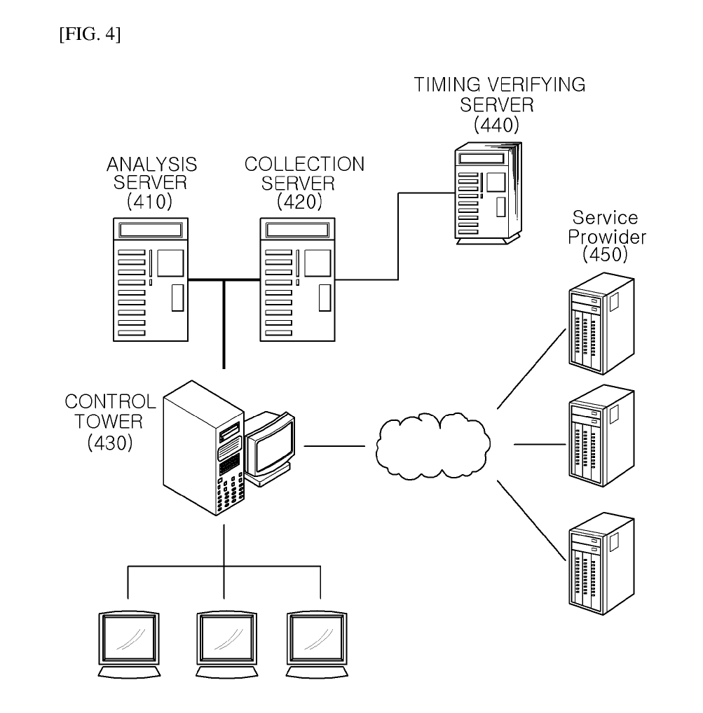

FIG. 4 is a configuration diagram of an online social network service data collecting and analyzing system.

The collection module 310 of FIG. 3 may be implemented by a collection server 420 of FIG. 4 and the analysis module 340 of FIG. 3 may be implemented by an analysis server 410 of FIG. 4. The conversion module 320, the integration module 30, the retrieval module 350, the user interface 360, and the event manager 370 of FIG. 3 may be implemented by a controller tower 430 of FIG. 4. The control tower 430 may leave a retrieval function to a service provider 450. A timing verifying server 440 of FIG. 4 may be used as a server for issuing the timestamp.

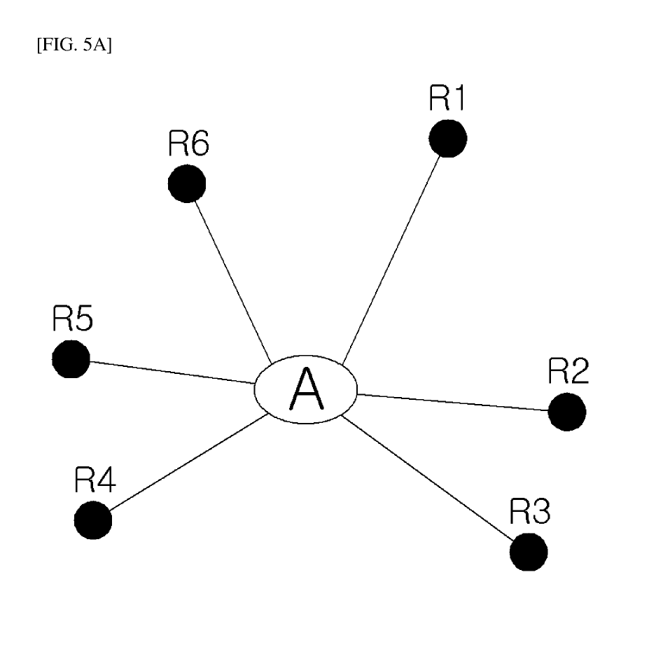

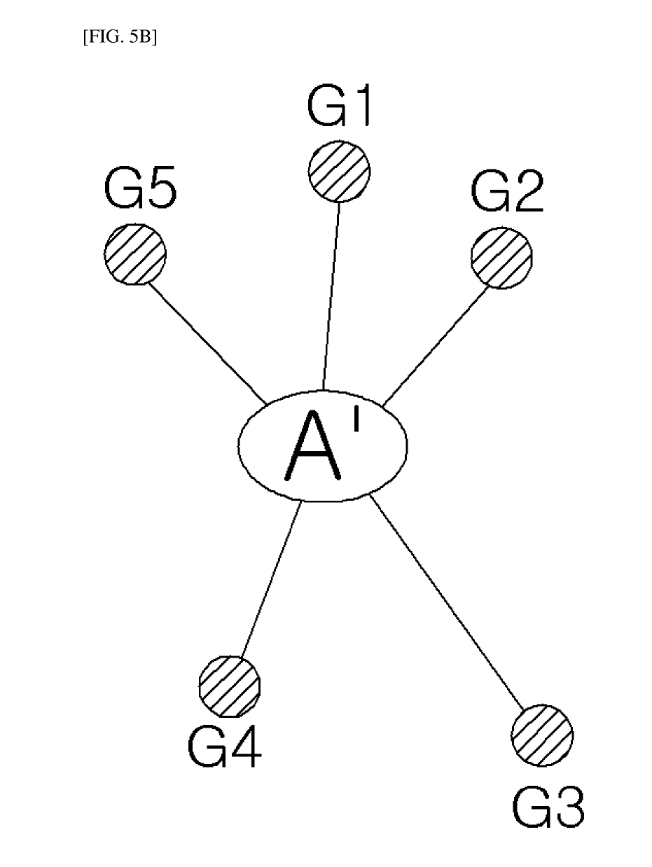

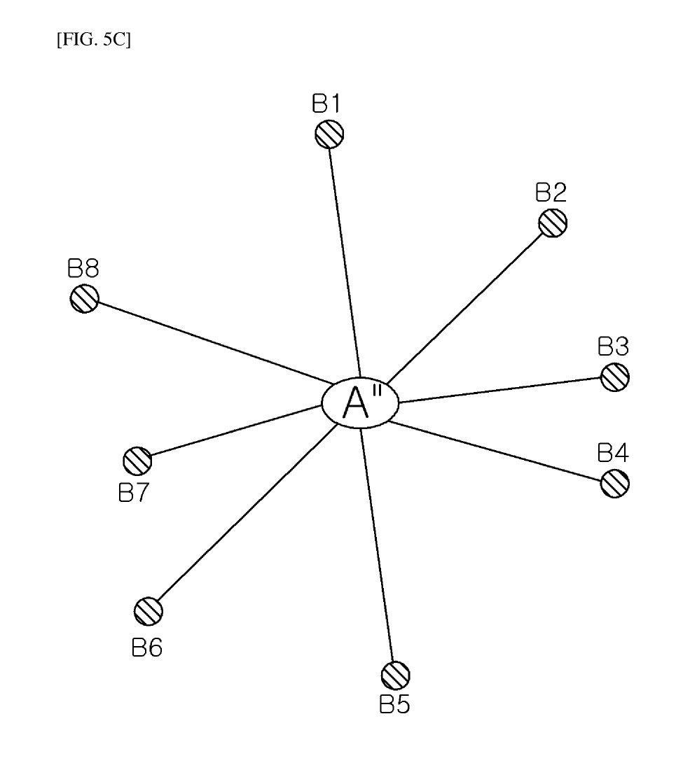

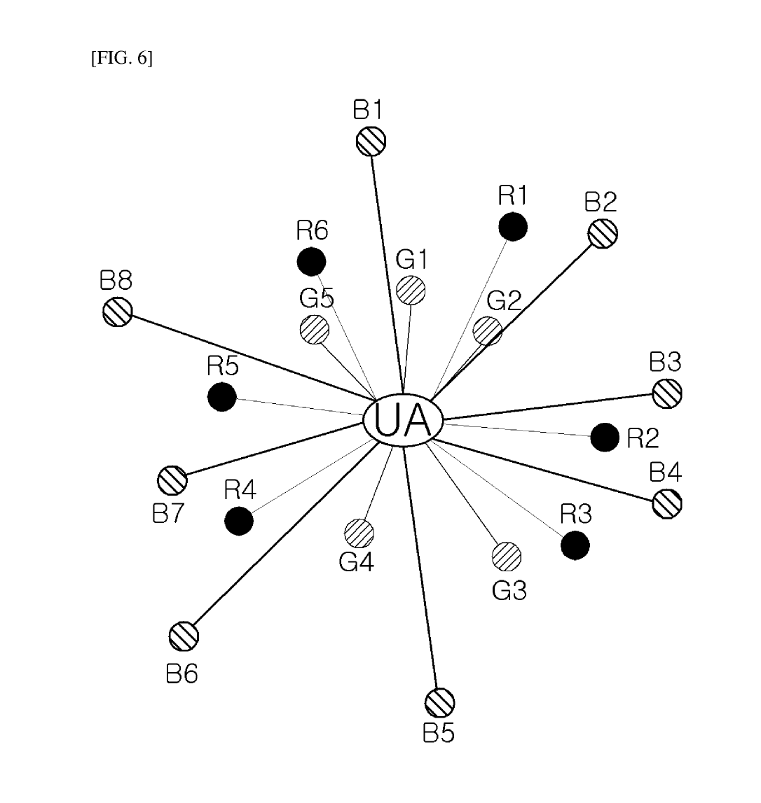

FIGS. 5A to 6 are exemplary diagrams of mergence of multiple social networks for one person.

FIGS. 5A, 5B, and 5C are diagrams illustrating respective networks in different colors on the assumption that each one person holds three social networks. FIG. 6 illustrates how the social network is changed when three social networks illustrated in FIGS. 5A, 5B, and 5C are just merged.

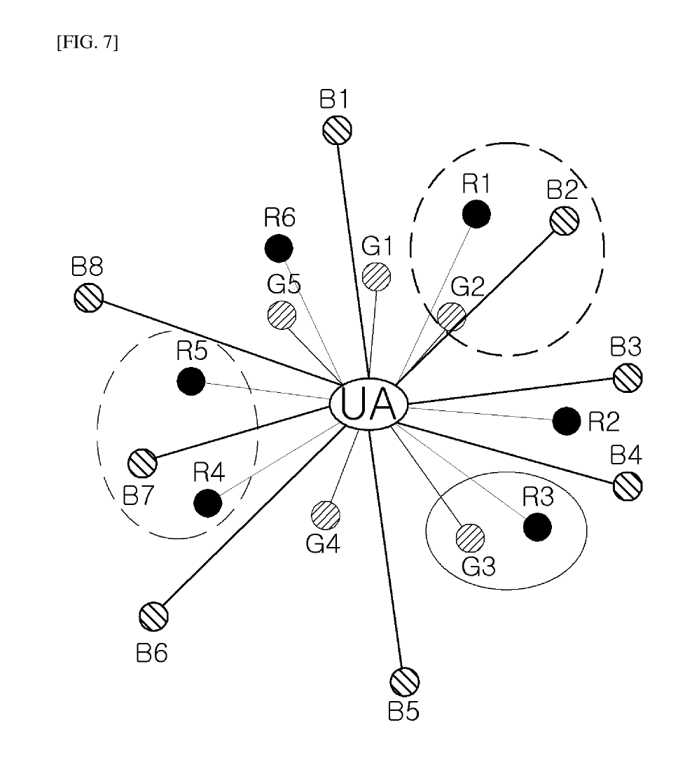

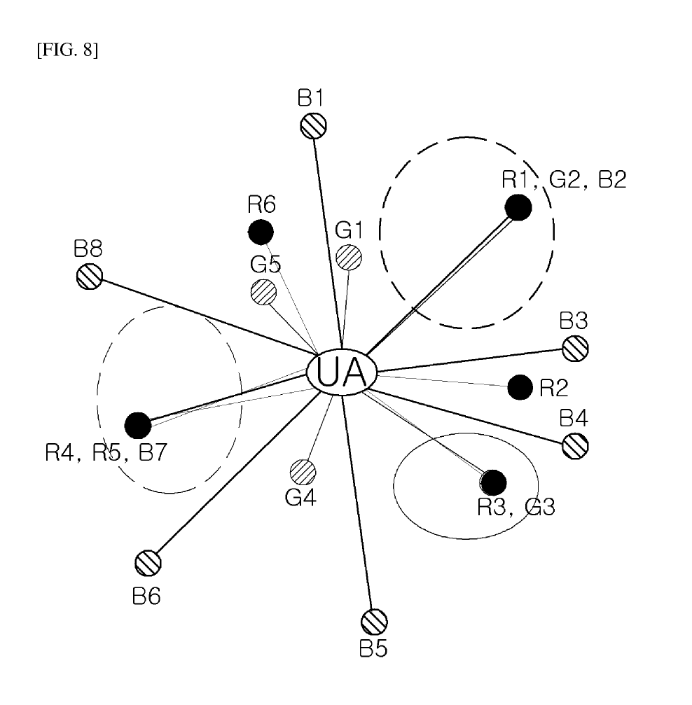

FIGS. 7 and 8 are exemplary diagrams illustrating a method of merging users having a friend relationship judged as the same person.

FIG. 7 is a picture displaying a person judged as the same person among friends in the social network merged in FIG. 6. FIG. 8 illustrates the social network by the picture after merging the friends judged as the same person into one person.

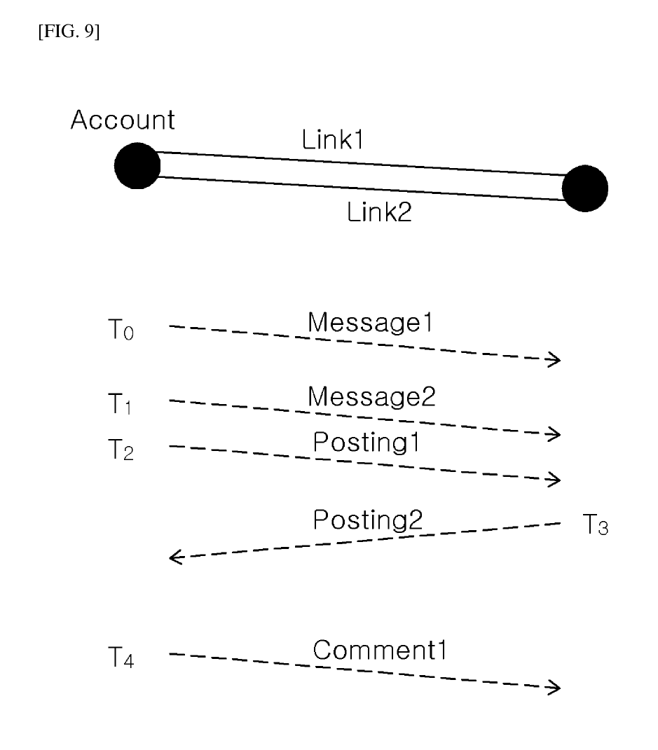

FIG. 9 is an exemplary diagram of arraying one example associated with interaction between two persons in chronological order.

In the event of Facebook, it is judged to directly send the message to the counterpart or directly perform posting on the wall of the counterpart instead of just making a comment on a notice as an expression of more intimacy. Therefore, the action may be weighted. However, since the social network service is various and an action considered as important may depend on a circumstance and an event, it is preferable that the analyzer may arbitrarily designate the weight.

However, it is verified how many interaction occurs between two persons during a specific period through quantification of interaction for a time term to be actually used to determine intimacy.

Therefore, an intimacy coefficient between two persons may be expressed by an equation below.

Intimacy coefficient=ΣWₐIₐ/(Tₜ−T₀)

Wₐ: Weight for specific interaction

Iₐ: Frequency of specific interaction

Tₜ-T₀: Time interval

The common data format for interaction between two persons may be defined as follows.
Interaction (message, writing which is left on walls of other persons, comment, action)

| - [Time] | //YYYY-MM-DD tt:mm:ss |
|---|---|
| - [Text] | // including text data |
| - [Content Link] | // Multimedia content link |
| - [Tag] | |
| - [Place] | |
| - [Link] | |
| - [Content type] | // message, posting, comment, |

action

| | |
|---|---|
| - [Related Posting Link] | // in the event of |

comment

| | |
|---|---|
| - [From] | // writer |

| | |
|---|---|
| - [To] | // related posting drafter in |

the event of comment

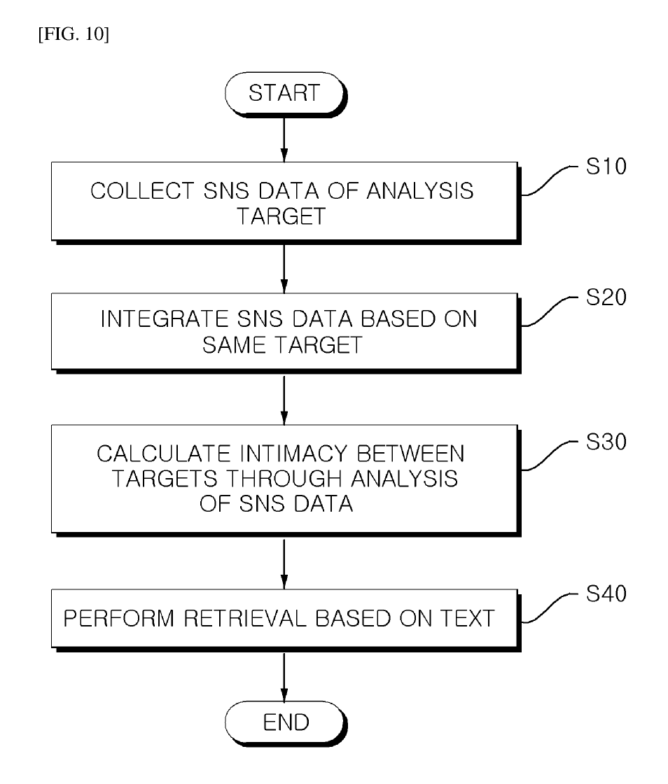

FIG. 10 is a flowchart schematically illustrating a method for analyzing SNS data of a social network forensic apparatus according to another exemplary embodiment of the present invention. A description below refers to FIGS. 1, 2, and 10.

First, the SNS data collecting unit 110 serves to collect social network service (SNS) data of analysis targets (S10). The SNS data collecting unit 110 may store SNS data of each analysis target which include a time when each SNS data is collected and identification information granted to each SNS data.

After step S10, the SNS data integrating unit 120 integrates SNS data of the same analysis target among the collected SNS data (S20). The SNS data integrating unit 120 may integrate SNS data stored in a database with the SNS data of each analysis target by using information on an input analysis target.

After step S20, the SNS data analyzing unit 130 calculates intimacy with other targets by analyzing the integrated SNS data (S30). The SNS data analyzing unit 130 may calculate intimacy by using relationship information with other targets acquired by connecting a social network service. In this event, the SNS data analyzing unit 130 may use a connection degree with other targets which are linked and a frequency of messages transmitted to and received from other targets as the relationship information.

After step S30, the SNS data retrieving unit 140 retrieves SNS data which conforms with an input text value among the integrated SNS data (S40).

Meanwhile, before step S10, the event related information collecting unit 170 may collect event related information associated with an input event. Then, the SNS data collecting unit 110 may collect the SNS data of each analysis target by connecting the social network service based on information on analysis targets included in the collected event related information.

Meanwhile, between steps S10 and S20, the SNS data converting unit 180 may convert each collected SNS data into data in a common format.

Meanwhile, after step S40, the analysis result reporting unit 190 may report the calculated intimacy and a retrieval result as an analysis result of the integrated SNS data.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A social network forensic apparatus, comprising:
an SNS data collecting unit collecting social network service (SNS) data of analysis targets;
an SNS data integrating unit integrating SNS data of the same analysis target among the collected SNS data;
an SNS data analyzing unit calculating intimacy with other targets by analyzing the integrated SNS data; and
an SNS data retrieving unit retrieving SNS data which conform with input text values among the integrated SNS data.

2. The apparatus of claim 1, further comprising:
an event related information collecting unit collecting event related information associated with an input event,
wherein the SNS data collecting unit collects the SNS data of each analysis target by connecting the social network service based on information on analysis targets included in the collected event related information.

3. The apparatus of claim 2, wherein:
the SNS data collecting unit stores SNS data of each analysis target which include a time when each SNS data is collected and identification information granted to each SNS data.

4. The apparatus of claim 1, further comprising:
an SNS data converting unit converting each collected SNS data into data in a common format.

5. The apparatus of claim 1, wherein:
the SNS data integrating unit integrates SNS data stored in a database with the SNS data of each analysis target by using information on an input analysis target.

6. The apparatus of claim 1, wherein:
the SNS data analyzing unit calculates the intimacy by using relationship information with other targets acquired by connecting a social network service.

7. The apparatus of claim 6, wherein:
the SNS data analyzing unit uses a connection degree with other targets which are linked and a frequency of messages transmitted to and received from other targets as the relationship information.

8. The apparatus of claim 1, further comprising:
an analysis result reporting unit reporting the calculated intimacy and a retrieval result as an analysis result of the integrated SNS data.

9. A method for analyzing SNS data of a social network forensic apparatus, the method comprising:
collecting social network service (SNS) data of analysis targets;
integrating SNS data of the same analysis target among the collected SNS data;
calculating intimacy with other targets by analyzing the integrated SNS data; and
retrieving SNS data which conform with input text values among the integrated SNS data.

10. The method of claim 9, further comprising:
collecting event related information associated with an input event,
wherein in the collecting of the SNS data, the SNS data of each analysis target are collected by connecting the social network service based on information on analysis targets included in the collected event related information.

11. The method of claim 10, wherein:
in the collecting of the SNS data, SNS data of each analysis target which include a time when each SNS data is collected and identification information granted to each SNS data are stored.

12. The method of claim 9, wherein:
in the analyzing of the SNS data, the intimacy is calculated by using relationship information with other targets acquired by connecting a social network service.
